(19) United States
(12) Patent Application Publication
(10) Pub. No.: US 2013/0026713 A1
(43) Pub. Date: Jan. 31, 2013

(54) ADVANCED BAG TOSS GAME

(71) Applicant: Javier A. Angel, Toledo, OH (US)

(72) Inventor: Javier A. Angel, Toledo, OH (US)

(21) Appl. No.: 13/560,007

(22) Filed: Jul. 27, 2012

Related U.S. Application Data
(60) Provisional application No. 61/513,322, filed on Jul. 29, 2011.

(51) Int. Cl. F41J 3/00; B23P 11/00

(52) U.S. Cl. 273/398; 29/428

(57) ABSTRACT

A non-planar target board, fascia boards connected to the non-planar target board, and support members connected to one or more of the fascia boards and the underside of the target board, form at least one target board assembly for an advanced bag toss game. A method of making the target board assembly is also a part of the invention.

### RELATED APPLICATIONS

This application is claiming the benefit under 35 U.S.C. 119(e), of the provisional application filed Jul. 29, 2011 under 35 U.S.C. 111(b), which was granted Ser. No. 61/513,322. This provisional application is hereby incorporated by reference in its entirety.

### BACKGROUND OF THE INVENTION

The invention relates to a bag toss game. More particularly, the invention relates to a bag toss game having a target board assembly configured so as to require a higher level of skill than known bag toss games. A method of making the target board assembly is also a part of the invention.

### SUMMARY OF THE INVENTION

The invention relates to a bag toss game requiring a higher level of skill than known bag toss games by introducing variations in the configuration of the target board, in contrast to the flat, planar surface of known bag toss games. Thus, the target board features a non-planar target board surface with a target hole located in a predetermined location relative to individual non-planar portions (e.g. curved portions) of the non-planar target board. The degree of difficulty of tossing the “bean bag” through the target hole will be influenced by this relationship between the location of the target hole and the non-planar portion or portions of the non-planar target board. Many such variations are possible and are within the scope of the invention.

At least one first and second fascia boards are connected to the non-planar target board to, among other things, provide structural support to the non-planar target board. One or more support members are connected to one or more of the first and second fascia boards in order to maintain the non-planar target board at a predetermined angle relative to the horizontal. A method of making the target board assembly is also a part of the invention. Certain accessories to the target board assembly may also be part of the invention.

### BRIEF DESCRIPTION OF THE DRAWINGS

The advantages of the present invention will become readily apparent to those skilled in the art from the following detailed description when considered in the light of the accompanying drawings. All drawings are perspective views unless specifically designated otherwise below.

FIG. 1 shows an embodiment according to the invention, wherein the non-planar target board has a continuous curvature including a pronounced curved portion and a more gently curved portion, a single target hole being located in the gently curved portion.

FIG. 2 shows an embodiment according to the invention, wherein the non-planar target board has a gently curving transition portion between upper and lower substantially planar portions, a single target hole being located in the upper substantially planar portion.

FIG. 3 shows an embodiment according to the invention, wherein the non-planar target board has a curved portion similar to FIG. 1, but having a less pronounced curvature and a substantially planar portion, a single target hole being located in the substantially planar portion.

FIG. 4a shows an embodiment according to the invention having a pronounced curved portion and two substantially planar portions, a single target hole being located at the peak of the curved portion.

FIG. 4b shows an embodiment according to the invention similar to that shown in FIG. 4a, but having a single target hole located in one of the two substantially planar portions.

FIG. 5 shows an embodiment according to the invention, wherein the non-planar target board has a pronounced curved portion, a more gently curved portion and a substantially planar portion, a single target hole being located at the peak of the portion having the pronounced curvature.

FIG. 6 shows an embodiment according to the invention, wherein the non-planar target board has a continuous curvature including a pronounced curved portion and a more gently curved portion, a target hole being located on an incline of the portion having the pronounced curvature, and a target hole being located in a decline of the more gently curved portion.

FIG. 7a shows an embodiment according to the invention, wherein the non-planar target board has a continuous curvature including two pronounced curved portions each bounded by more gently curved portions, a single target hole being located in one of the more gently curved portions.

FIG. 7b shows an embodiment according to the invention, similar to that shown in FIG. 7a, but having multiple target holes located in more than one of the more gently curved portions, and a handhold and wheels for convenient transport of the target board assembly.

FIG. 8 shows an embodiment according to the invention, the target board having a pronounced curved portion extending in a longitudinal direction bounded by two more gently curved portions and having a single target hole located at the peak of the curved portion having the pronounced longitudinal curvature and near the elevated end of the target board.

FIG. 9 shows an embodiment according to the invention, the target board having pronounced curved portions extending in both the transverse and longitudinal directions and then flowing into a portion more gently curved in the transverse direction, a single target hole being located in the portion having the combined transverse and longitudinal curvature.

FIG. 10 shows the underside if the target board assembly according to the invention with optional reinforcing member.

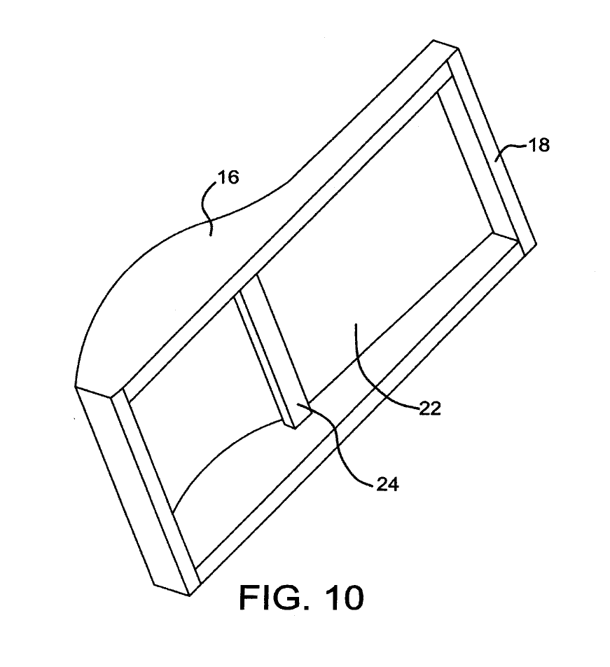

FIG. 11 shows a known bag toss game having a conventional planar target board surface.

### DETAILED DESCRIPTION OF THE INVENTION

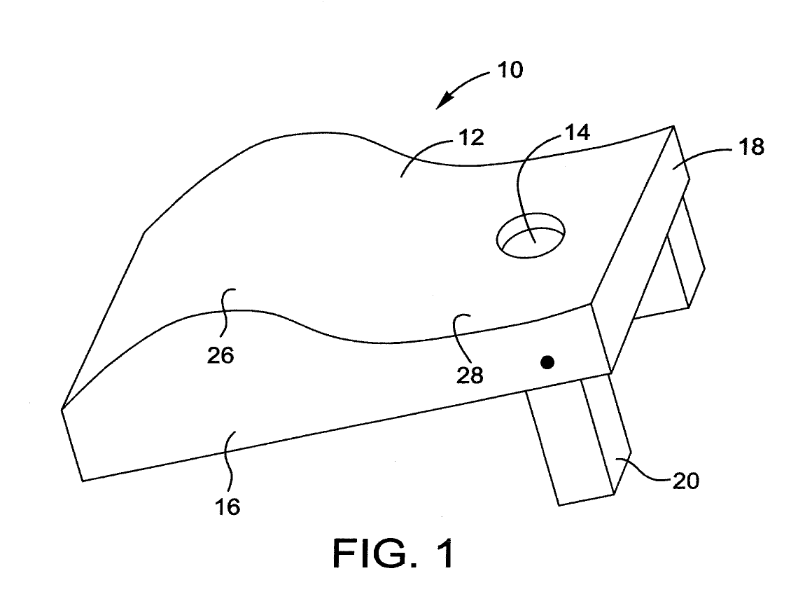

The invention relates to a bag toss game. More particularly, the invention relates to a bag toss game requiring a higher level of skill than known bag toss games by introducing variations in the configuration of a target board, i.e. the target board is “non-planar”. The non-planar target board 12 is a primary component of a target board assembly 10. Generally, at least two such target board assemblies 10 are utilized in the bag toss game. By “non-planar”, it is meant that the inventive target board 12 has one or more curved portions, which curved portions may differ in amplitude. Such curved portions may extend transversely across the entire width or only across a portion of the width of the target board. It is also within the scope of the invention that the curved portions may extend longitudinally along the entire length or only a portion of the length of the target board. Such curved portions may also be variously combined with one or more substantially planar portions to form different “non-planar” configurations. One or more target holes 14 may be located proximate the one or curved portions or the one or more substantially planar portions to create higher or lower degrees of difficulty for players of the game. Examples of such variations of target board configuration are shown in FIGS. 1-3, 4a, 4b, 5-6, 7a, 7b, and 8-9.

By “curve” is meant “to have or take a turn, change or deviation from a straight line or course or from a level surface typically with a rounded gradual effect and without sharp breaks or angularity”. (Webster's Third New International Dictionary, Merriam-Webster, Inc., 1986, pg. 558.)

By “simple curve” is meant “a circular arc joining two tangents” (Webster's Third New International Dictionary, id. at pg. 2121.)

By “compound curve” is meant “a curve made up of two or more circular arcs of successively shorter or longer radii joined tangentially”. (Webster's, id. at pg. 467.)

As previously noted herein, “curved” as used in this application is meant to apply not just to a line, but to a planar surface as well.

Other components of the target board assembly 10 in addition to the non-planar target board 12 include at least one first fascia board 16 which is connected to the non-planar target board 12. Preferably, the at least one first fascia board 16 is connected to a peripheral portion of the non-planar target board 12, by any suitable method, for example, by a suitable adhesive material, or by suitable mechanical fasteners such as nails, screws, staples and the like. Preferably, when connected to the non-planar target board 12, the at least one fascia board 16 is oriented at a right angle (90°) relative to the non-planar target board 12. The at least one first fascia board 16 preferably has a length substantially equal to the length of the non-planar target board 12. The at least one first fascia board 16 may have any desired width and may have at least one edge which conforms substantially to the configuration of the non-planar target board 12. The at least one first fascia board 16 preferably provides desired structural rigidity to the non-planar target board 12, provides a structure to which the at least one vertical support member 20 can be readily attached, and may be aesthetically appealing.

Similarly, the target board assembly 10 includes at least one second fascia board 18, preferably connected to a peripheral portion of the non-planar target board 12 by a suitable adhesive material or mechanical fasteners. The length of the at least one second fascia board 18 is substantially equal to the width of the non-planar target board 12. The at least one second fascia board 18 may have any desired width. The at least one second fascia board 18 may provide similar functions to the first fascia board 16.

The target board assembly 10 includes at least one support member 20 which can be attached to one or more of the at least one first fascia board 16, the at least one second fascia board 18 or the underside of the non-planar target board 12 by any suitable method, for example, adhesively, by one or more types of mechanical fasteners or by friction fit in notches or pockets formed in the first or second fascia boards (16,18) or the non-planar target board 12. The at least one support member 20 supports the target board 12 at a predetermined angle relative to the horizontal when the target board assembly 10 is in use. Typically, the predetermined angle of the target board 12 is between about 0° and about 60°, although other angles of inclination are possible.

Optionally, the target board assembly 10 may include a reinforcing member 24 to prevent flexing of the target board 12 when a tossed “bean bag” impacts it. The reinforcing member 24 may also provide additional lateral rigidity. If present, the optional reinforcing member 24 may be attached to the first fascia boards 16.

The inventive target board assembly 10 may be made from one material or a combination of suitable materials, for example, wood, a polymeric material, fiberglass cloth/resin, stretched cloth, stretch screen mesh or the like.

While the non-planar target board 12 may have any suitable dimensions, preferred dimensions are about 2 feet wide and about 4 feet long. The at least one target hole 14 is preferably about 6 inches in diameter. Generally, so as not to make the game unplayably difficult, the target hole 14 is located at least about 9 inches inboard from any peripheral edge of the non-planar target board 12. The support members 20 may have any desirable length, but are preferably about 12 inches long.

Of course, the target board assembly 10 can be decorated in any manner desired by the purchaser.

The inventive target board assembly 10 may be made by any suitable method. In a preferred method, a non-planar target board 12 having a desired length, width and thickness is formed in the desired non-planar shape. As previously noted, suitable materials for the non-planar target board 12 may include wood, polymeric material and fiberglass cloth/resin. As such, any of these materials may be formed into the desired shape by, for example, appropriate molding processes.

At least one target hole 14 may be formed at a predetermined location in the non-planar target board 12 by any suitable method, for example, drilling, routing, sawing, etc.

The at least one first fascia board 16 and the at least one second fascia board 18 may be fabricated by any suitable method dependent on the material utilized, and are connected, preferably adhesively or by mechanical fasteners, generally to a peripheral portion of the non-planar target board 12 and oriented at 90° to the non-planar target board 12.

Similarly, the at least one support member 20 is preferably connected to one or more of the first and second fascia boards (16,18), adhesively or by mechanical fasteners or combinations of the two, although other connection methods may be possible.

In addition to the invention as more generally described, illustrative embodiments of the non-planar target board 12 will now be described in relation to the drawings which comprise a portion of this application.

In an embodiment shown in FIG. 1, the non-planar target board 12 has a generally continuous curvature including a pronounced curved portion 26 flowing into a more gently curved portion 28 with a single target hole 14 located in the more gently curved portion 28.

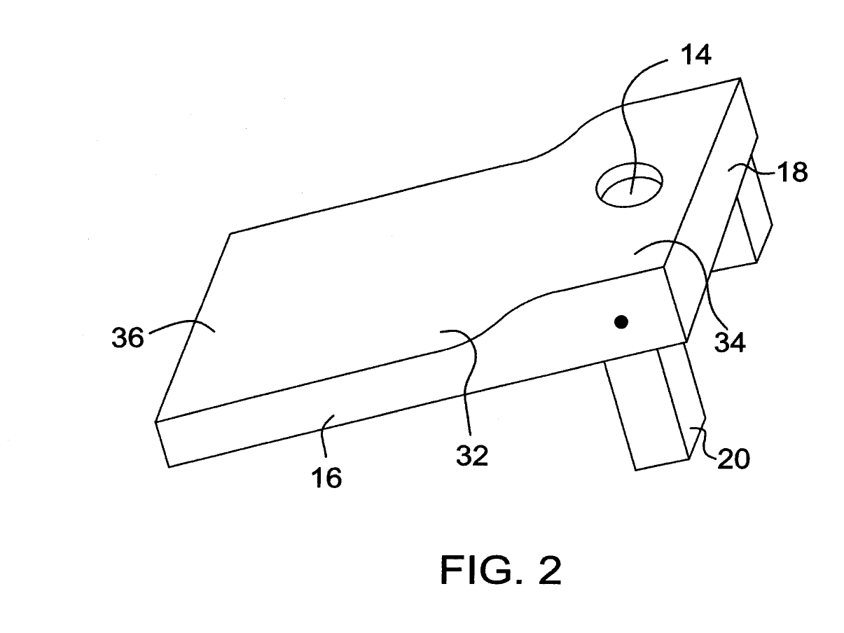

In another embodiment shown in FIG. 2, the non-planar target board 12 has a gently curving transition portion 32 joining an upper substantially planar portion 34 and a lower substantially planar portion 36 with a single target hole 14 located in the upper substantially planar portion 34.

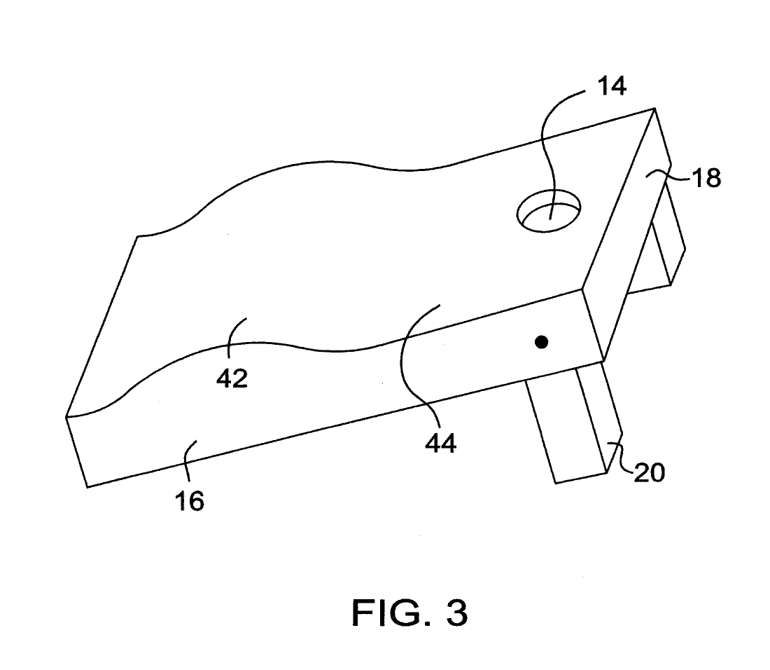

In a further embodiment shown in FIG. 3, the non-planar target board 12 has a curved portion 42 similar to FIG. 1, but of slightly smaller amplitude which flows into a substantially planar portion 44 with a single target hole 14 located in the substantially planar portion 44.

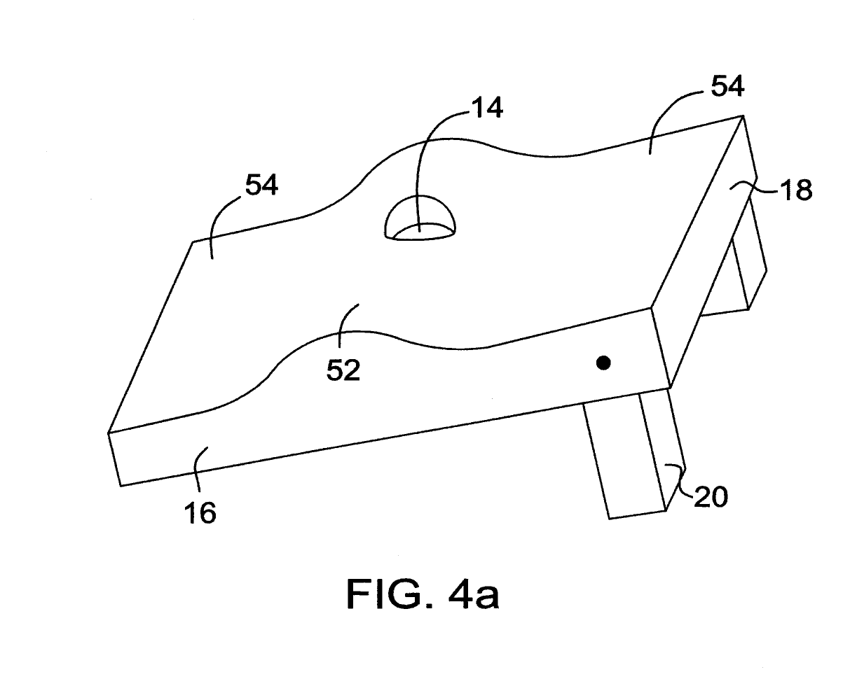

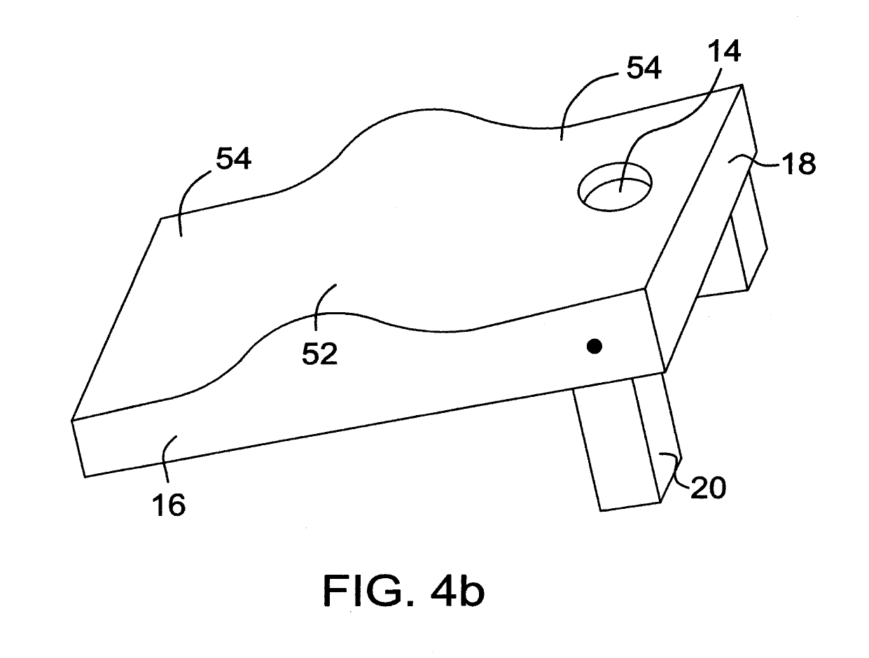

In yet another embodiment shown in FIGS. 4a and 4b, the non-planar target board 12 has a pronounced transversely curved portion 52 bounded by two substantially equivalent planar portions 54. In the variant of FIG. 4a the single target hole 14 is located at the peak of the curved portion 52. In the variant shown in FIG. 4b the single target hole 14 is located in one of the two substantially planar portions 54.

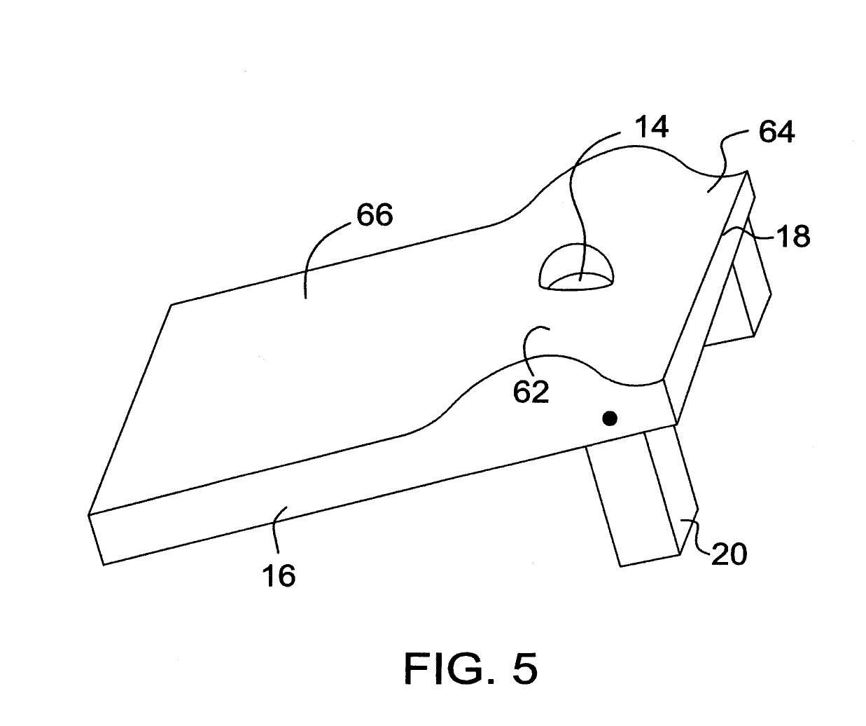

In still another embodiment shown in FIG. 5, the non-planar target board 12 has a pronounced transversely curved portion 62 bounded by a more gently transversely curved portion 64 and a substantially planar portion 66, the more gently transversely curved portion 64 being smaller than the substantially planar portion 66, with a single target hole 14 located at the peak of the portion 62 having the pronounced curvature.

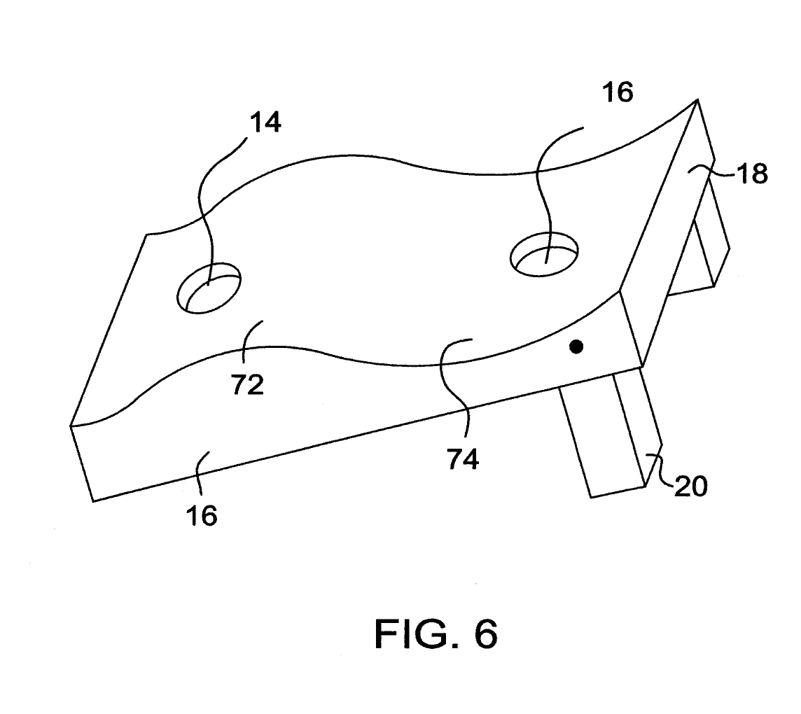

In still another embodiment shown in FIG. 6, the non-planar target board 12 has a continuous curvature including a pronounced transversely curved portion 72 flowing into a more gently transversely curved portion 74. A first target hole 14 is located on an incline of the portion of the non-planar target board 12 having the pronounced curvature 72, and a second target hole 16 is located in a decline of the more gently curved portion 74.

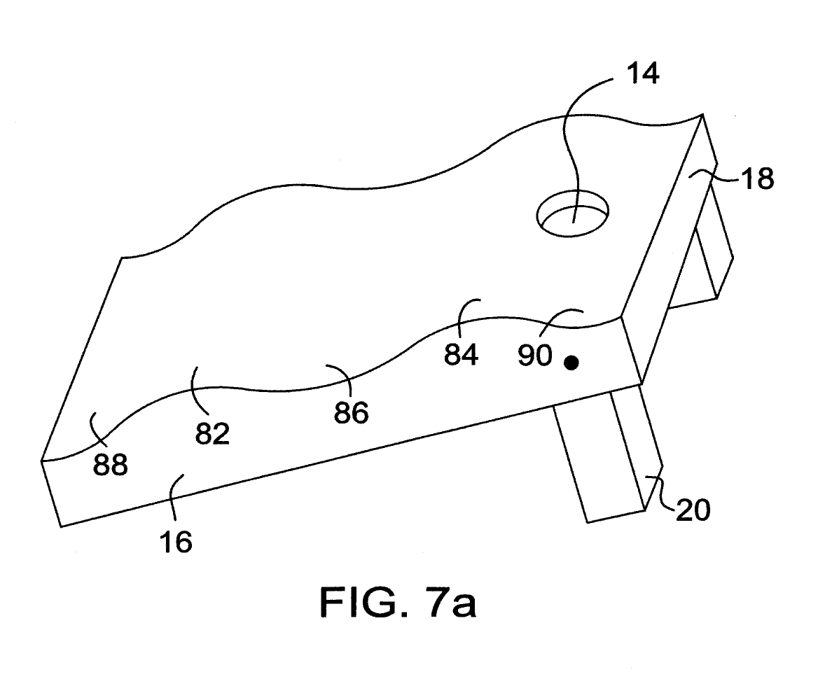

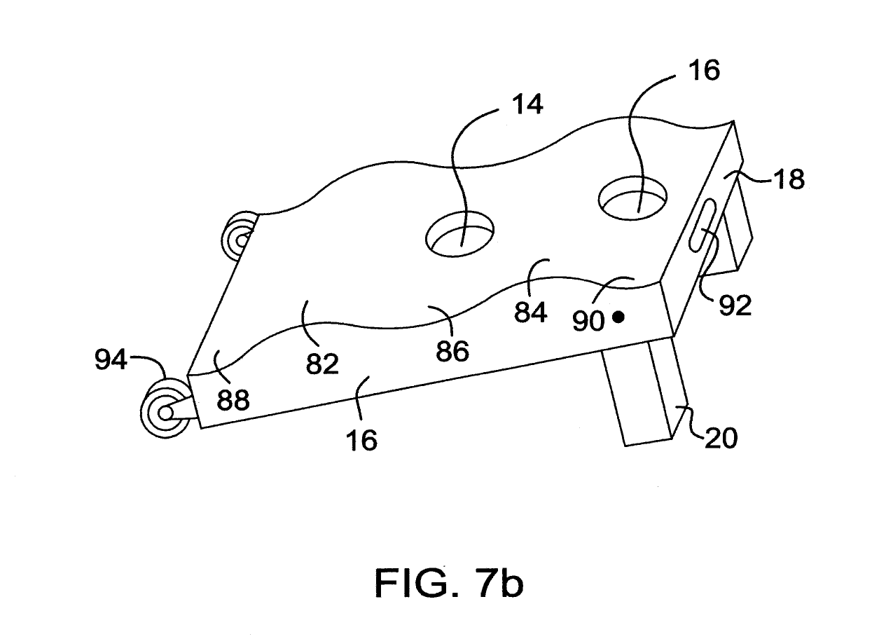

In yet another embodiment shown in FIGS. 7a and 7b, the non-planar target board 12 has a continuous curvature including two portions (82,84) having pronounced transverse curvatures, each bounded by more gently transversely curved portions (86, 88, 90). In the variant shown in FIG. 7a, a single target hole 14 is located in one of the more gently curved portions 90. In the variant shown in FIG. 7b, a first and a second target hole (14,16) are located in two different of the gently curved portions (86,90). An opening (handhold) 92 is formed in one of the second fascia boards 18, and one or more rollers/wheels 94 are attached to the opposite second fascia board 18 to allow for convenient transport of the target board assembly 10.

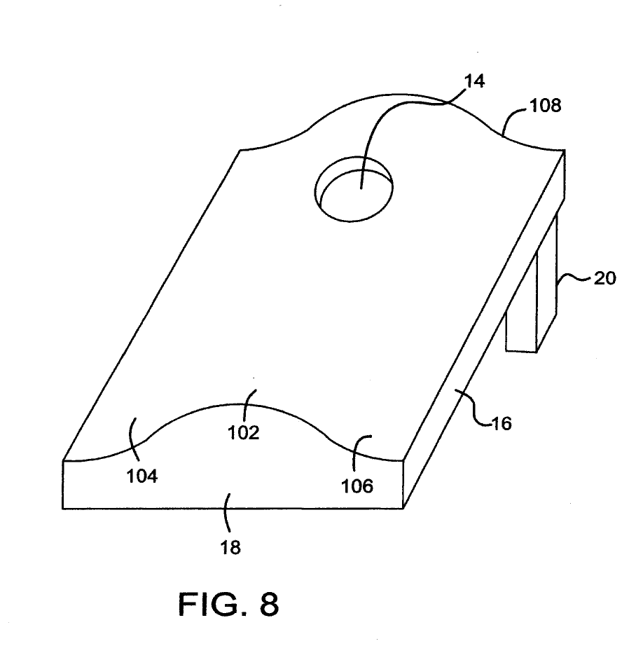

In still another embodiment shown in FIG. 8, the non-planar target board 12 has a pronounced curved portion 102 extending in a longitudinal direction, bounded by two more gently longitudinally curved portions (104,106) and having a single target hole 14 located at the peak of the curved portion 102 having the pronounced curvature, the target hole 14 also being near the end of the target board 108 elevated by the support members.

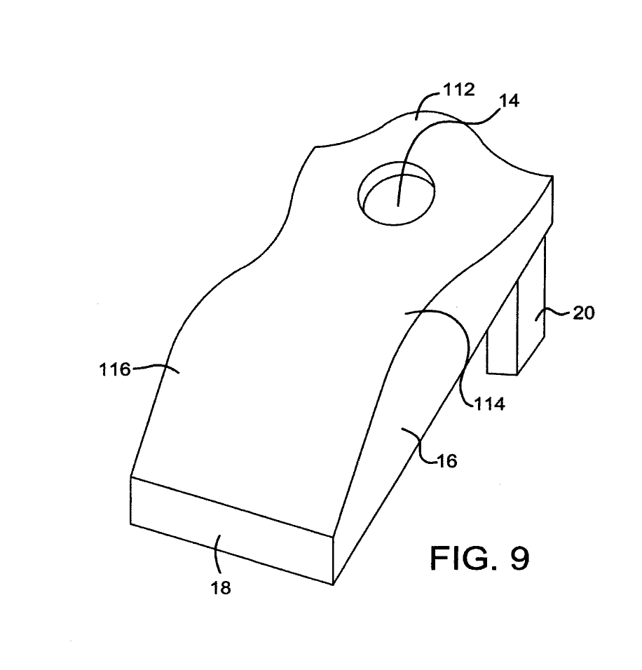

In yet another embodiment shown in FIG. 9, the non-planar target board 12 has pronounced curved portions (112,114) extending in both the transverse and longitudinal directions, which portion then flows into a portion 116 more gently curved, primarily in the transverse direction. A single target hole 14 is located in the portion of the non-planar target board (112,114) having the combined transverse and longitudinal curvatures.

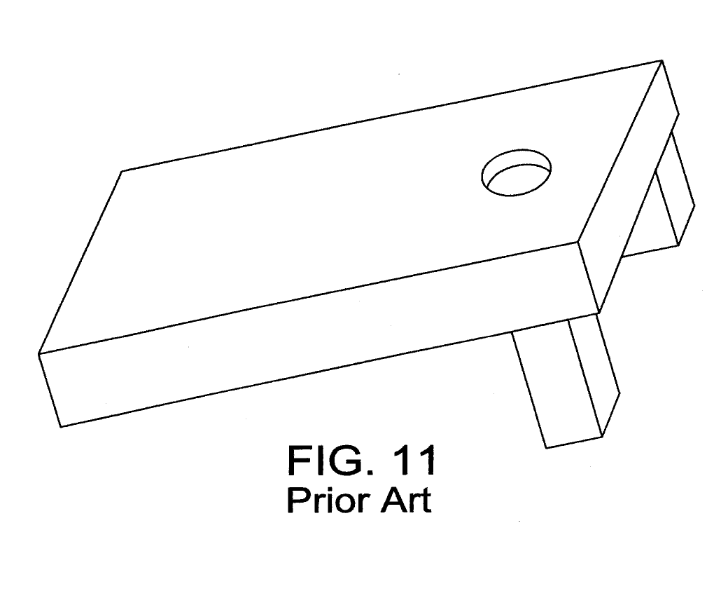

FIG. 11 illustrates a known bag toss game target board having a conventional planar target board surface.

The invention has been described in what is considered to be its best mode. Those skilled in the art will, however, appreciate that the invention may be otherwise practiced without departing from the spirit and scope of the invention described herein.

What is claimed is:

1. At least one target board assembly comprising:
a non-planar target board having: a predetermined length, width and thickness, a peripheral edge portion, and at least one target hole formed therethrough;
at least one first fascia board having a length substantially equal to the length of the non-planar target board, and connected to the length-wise peripheral portion of the non-planar target board in a substantially perpendicular orientation to the non-planar target board;
at least one second fascia board having a length substantially equal to the width of the non-planar target board, and connected to the width-wise peripheral portion of the non-planar target in a substantially perpendicular orientation to the non-planar target board; and
at least one support member attached to one or more of the first and second fascia boards, so as to support the non-planar target board at a predetermined angle relative to the horizontal.

2. The at least one target board assembly defined in claim 1, wherein the non-planar target board comprises at least one simple curved portion.

3. The at least one target board assembly defined in claim 1, wherein the non-planar target board comprises at least one compound curved portion.

4. The at least one target board assembly defined in claim 1, wherein the non-planar target board comprises one or more curved portions and one or more substantially planar portions.

5. The at least one target board assembly defined in claim 1, wherein the non-planar target board has at least two target holes formed therethrough.

6. The at least one target board assembly defined in claim 1, wherein at least the non-planar target board comprises wood.

7. The at least one target board assembly defined in claim 1, wherein at least the non-planar target board comprises a polymeric material.

8. The at least one target board assembly defined in claim 1, wherein at least the non-planar target board comprises fiberglass cloth coated with resin.

9. A method of forming a target board assembly comprising:
forming a non-planar target board having a length, a width, a thickness and a peripheral edge portion in the desired non-planar shape;
forming at least one target hole in a predetermined location in the non-planar target board;
connecting at least one first fascia board having a length substantially equal to the length of the non-planar target board to the peripheral portion of the non-planar target board and oriented perpendicularly to the non-planar target board;
connecting at least one second fascia board having a length substantially equal to the width of the non-planar target board to the peripheral portion of the non-planar target board and oriented perpendicularly to the non-planar target board; and
connecting at least one support member to one or more of the first and second fascia boards, so as to support the non-planar target board at a predetermined angle relative to the horizontal.

10. The method of forming a target board assembly defined in claim 9, wherein the non-planar target board is molded.

11. The method of forming a target board assembly defined in claim 9, wherein the non-planar target board and the at least first and second fascia boards are adhesively connected.

12. The method of forming the target board assembly defined in claim 9, wherein the non-planar target board, the at least first and second fascia boards and the at least one support member are mechanically connected to one another.
